(19) United States
(12) Patent Application Publication
(10) Pub. No.: US 2024/0083772 A1
(43) Pub. Date: Mar. 14, 2024

(54) FAUCET INLET HOSE ASSEMBLY WITH INTEGRATED FILTER

(71) Applicant: AS America, Inc., Piscataway, NJ (US)

(72) Inventors: Xiaoping ZHENG, Guangzhou (CN); Xiaojing YE, Edison, NJ (US)

(73) Assignee: AS America, Inc., Piscataway, NJ (US)

(21) Appl. No.: 18/274,931

(22) PCT Filed: Feb. 2, 2022
(86) PCT No.: PCT/US2022/070486

§ 371 Date: Jul. 28, 2023

(30) Foreign Application Priority Data
Feb. 7, 2021 (WO) PCT/CN2021/075791

(51) Int. Cl. C02F 1/00; E03C 1/04

(52) U.S. Cl. CPC C02F 1/003; E03C 1/04; C02F 2201/005; C02F 2307/06; E03C 2201/40

(57) ABSTRACT

Provided are faucet inlet hose assemblies comprising an integrated filter. A faucet inlet hose assembly having an integrated filter comprises a hose comprising a first hose end and a second hose end; a first coupling fitting, wherein the first hose end terminates at the first coupling fitting; a second coupling fitting, wherein the second hose end terminates at the second coupling fitting; a hose connector connected to the first hose end; and a filter at least partially within the first coupling fitting and coupled to the hose connector.

### REFERENCE TO RELATED APPLICATIONS

This application claims the benefit of PCT International Application No. PCT/CN2021/075791, filed Feb. 7, 2021, the entire contents of which are hereby incorporated by reference herein.

### FIELD

The present disclosure relates to a faucet inlet hose assemblies, and more particularly, to faucet inlet hose assemblies having an integrated filter.

### BACKGROUND

Conventional faucet inlet hose assemblies simply transport water from the shut off valve of the water supply pipeline to the faucet of a sink. Adaptor assemblies can be coupled to conventional faucet inlet hoses to filter any impurities from the water and prevent the impurities from passing through the faucet.

### SUMMARY OF THE DISCLOSURE

Many conventional faucet inlet hoses, such as those described above, are not designed to filter out impurities. Instead, to achieve filtered water, an adaptor assembly must be connected to the conventional faucet inlet hose assembly. Thus, conventional faucet inlet hose assemblies require additional cost, installation time, and parts to filter impurities from the water and deliver filtered water to the faucet.

Accordingly, provided herein are faucet inlet hose assemblies having an integrated filter. The filter of faucet inlet hose assembly according to embodiments provided herein can removably couple to a hose connector of the faucet inlet hose assembly. Further, the filters described herein can prevent the flow of impurities (e.g., minerals, sediment, debris) into and out of the faucet. Thus, a faucet inlet hose assembly having an integrated filter as provided herein can reduce the cost, installation time, and number of parts necessary to achieve a faucet inlet hose that filters impurities from the water flowing into and out of a faucet to which the faucet inlet hose assembly is connected.

In some embodiments, provided is a faucet inlet hose assembly having an integrated filter, the faucet inlet hose assembly comprising: a hose comprising a first hose end and a second hose end; a first coupling fitting, wherein the first hose end terminates at the first coupling fitting; a second coupling fitting, wherein the second hose end terminates at the second coupling fitting; a hose connector connected to the first hose end; and a filter at least partially within the first coupling fitting and coupled to the hose connector.

In some embodiments of the faucet inlet hose assembly, the first coupling fitting comprises a check valve, a nut, and the hose connector.

In some embodiments of the faucet inlet hose assembly, the filter comprises a convex portion and a connection portion, and the convex portion extends away from the first hose end.

In some embodiments of the faucet inlet hose assembly, the first coupling fitting is configured to connect to a water source.

In some embodiments of the faucet inlet hose assembly, the first coupling fitting is configured to connect to a faucet.

In some embodiments of the faucet inlet hose assembly, the connection portion comprises a fitting that removably connects to the check valve.

In some embodiments of the faucet inlet hose assembly, the fitting comprises a snap fitting.

In some embodiments of the faucet inlet hose assembly, the second coupling fitting comprises a nut.

In some embodiments of the faucet inlet hose assembly, the filter comprises a plurality of channels.

In some embodiments of the faucet inlet hose assembly, each channel of the plurality of channels extends from the convex portion towards the connection portion.

In some embodiments of the faucet inlet hose assembly, the plurality of channels comprises 15-25 channels.

In some embodiments of the faucet inlet hose assembly, the plurality of channels are substantially evenly spaced around the filter.

In some embodiments of the faucet inlet hose assembly, a length of a first channel of the plurality of channels is greater than a length of a second channel of the plurality of channels, wherein a length is measured along a surface of the filter extending from the convex portion to the connection portion.

In some embodiments of the faucet inlet hose assembly, a length of each channel of the plurality of channels extends from about 50% to about 80% of a total distance measured along an exterior surface of the filter extending from a center of the convex portion to a bottommost location of the connection portion.

In some embodiments of the faucet inlet hose assembly, the filter comprises a gripping protrusion extending from a center of the convex portion, the gripping protrusion configured to allow a tool to grip the filter.

In some embodiments of the faucet inlet hose assembly, the filter comprises a plurality of cut-outs extending from the connection portion towards the convex portion.

In some embodiments of the faucet inlet hose assembly, each cut-out of the plurality of cut-outs extends from about 50% to about 80% of a total distance measured along an exterior surface of the filter extending from a center of the convex portion to a bottommost location of the connection portion.

In some embodiments of the faucet inlet hose assembly, the filter comprises a metal or a thermoplastic or elastomer.

In some embodiments of the faucet inlet hose assembly, the filter comprises one or more of a metal such as stainless steel, aluminum, or brass; a thermoplastic such as polyamide, acrylic, polycarbonate, polyoxymethylene, polyester, polystyrene, polypropylene, polyethylene, polyurethane, polyphenylene sulfite, polyphenylene oxide, polysulfone, polyphthalamide, combinations thereof or copolymers thereof; or an elastomer such as acrylonitrile-butadiene-styrene or silicone rubber.

In some embodiments, a filter for a faucet inlet hose assembly is provided, the filter comprising: a convex portion; and a connection portion opposite the convex portion, wherein the connection portion is configured to removably couple to a hose connector of a faucet inlet hose.

In some embodiments of the filter, the connection portion comprises a snap fitting.

In some embodiments of the filter, the filter comprises a plurality of channels.

In some embodiments of the filter, each channel of the plurality of channels extends from the convex portion towards the connection portion of the filter.

In some embodiments of the filter, the plurality of channels comprises 15-25 channels.

In some embodiments of the filter, the plurality of channels are substantially evenly spaced around the filter.

In some embodiments of the filter, a length of a first channel of the plurality of channels is greater than a length of a second channel of the plurality of channels, wherein a length is measured along a surface of the filter extending from the convex portion to the connection portion.

In some embodiments of the filter, a length of each channel of the plurality of channels extends from about 50% to about 80% of a total distance measured along an exterior surface of the filter extending from a center of the convex portion to a bottommost location of the connection portion.

In some embodiments of the filter, the filter comprises a gripping protrusion extending from a center of the convex portion, the gripping protrusion configured to allow a tool to grip the filter.

In some embodiments of the filter, the filter comprises a plurality of cut-outs extending from the connection portion towards the convex portion.

In some embodiments of the filter, each cut-out of the plurality of cut-outs extends from about 50% to about 80% of a total distance measured along an exterior surface of the filter extending from a center of the convex portion to a bottommost location of the connection portion.

In some embodiments of the filter, the filter comprises one or more of a metal such as stainless steel, aluminum, or brass; a thermoplastic such as polyamide, acrylic, polycarbonate, polyoxymethylene, polyester, polystyrene, polypropylene, polyethylene, polyurethane, polyphenylene sulfite, polyphenylene oxide, polysulfone, polyphthalamide, combinations thereof or copolymers thereof; or an elastomer such as acrylonitrile-butadiene-styrene or silicone rubber.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIG. 1A illustrates a cross-sectional broken view of a faucet inlet hose assembly, according to some embodiments;

FIG. 1B illustrates a cross-sectional view of a second hose end of a faucet inlet hose assembly configured to couple to a faucet, according to some embodiments;

FIG. 1C illustrates a cross-sectional view of a first hose end of a faucet inlet hose assembly configured to couple to a water supply valve, according to some embodiments;

FIG. 1D illustrates a bottom view of a filter, according to some embodiments;

FIG. 1E illustrates a cross-sectional view of a filter along a central axis running from a center of the convex portion through a center of the connection portion, according to some embodiments:

FIG. 1F illustrates a top view of a filter, according to some embodiments;

FIG. 1G illustrates a cross-sectional view of a filter along a central axis running from a center of the convex portion through a center of the connection portion, according to some embodiments:

FIG. 1H illustrates a side view of a filter, according to some embodiments; and

FIG. 1I illustrates a close-up view of a coupling protrusion, according to some embodiments.

FIG. 2A shows a picture of a faucet inlet hose assembly for cold water and a faucet inlet hose assembly for hot water comprising an integrated filter, according to some embodiments; and

FIG. 2B shows a picture of a faucet inlet hose assembly comprising an integrated filter, according to some embodiments.

### DETAILED DESCRIPTION OF THE DISCLOSURE

Described herein are faucet inlet hose assemblies having an integrated filter, as well as filters for faucet inlet hose assemblies. As described above, conventional faucet inlet hose assemblies require the addition of a separate adaptor filter assembly to filter impurities from the water that passes out through the faucet. As provided herein, faucet inlet hose assemblies having an integrated filter can prevent impurities from entering the inlet hose and passing through the faucet without the need for an additional adaptor assembly. The filters described can be used as replacement filters for faucet inlet hose assemblies having an integrated filter and/or they can be installed into conventional faucet inlet hose assemblies. Faucet inlet hose assemblies comprising an integrated filter as described herein can also extend the lifetime of the hose, since they can filter impurities from entering and building up in the hose.

The faucet inlet hose assemblies, described in detail below, include a first hose end and a second hose end. The first hose end terminates at a first coupling fitting and the second hose end terminates at a second coupling fitting. One coupling fitting (i.e., the first coupling fitting or the second coupling fitting) is configured to connect to a water source. Another end (i.e., the first hose end or the second hose end) is configured to connect to the device (e.g., faucet of a sink). In some embodiments, the integrated filter may be positioned at the first hose end. In some embodiments, the integrated filter may be positioned at the second hose end. In some embodiments, the integrated filter may be removably attached to the hose assembly allowing for the filter to be removed for cleaning and replacement.

The filter according to embodiments described herein includes one end (i.e., the top of the filter) that is convex-shaped (i.e., the convex portion). The other end of the filter (i.e., the bottom of the filter) is a connection portion. The connection portion of the filter is configured to couple to an end (i.e., a first hose end or a second hose end) of the faucet inlet hose. In some embodiments, the connection portion is configured to couple to one or more of a check valve, a hose connector, or a nut of the hose end.

In some embodiments, filters for faucet inlet hose assemblies comprise a plurality of channels. The plurality of channels allow for water to pass through the filter. Ideally, the channels are shaped such that they prevent the passage of common debris, sediment, and/or mineral buildup. Thus, the filter, by way of the plurality of channels, cleans the water that flow to and out through the faucet.

The faucet inlet hose assemblies and filters for faucet inlet hose assemblies provided herein can be used in a variety of devices. For example, faucet inlet hose assemblies and filters for faucet inlet hose assemblies provided herein may be used for bathroom sinks, kitchen sinks, garage/utility sinks, dishwashers, washing machines, toilets, refigerators (e.g., ice makers), and other similar devices.

In some embodiments, filters may comprise a metal. For example, a filter may comprise a metal such as stainless steel, aluminum, brass, or the like. In some embodiments, a filter may comprise a thermoplastic, for example polyamide, acrylic, polycarbonate, polyoxymethylene, polyester, polystyrene, polypropylene, polyethylene, polyurethane, polyphenylene sulfite, polyphenylene oxide, polysulfone, polyphthalamide, combinations thereof or copolymers thereof. In some embodiments, a filter may comprise an elastomer, for example acrylonitrile-butadiene-styrene, silicone rubber, etc.

In some embodiments, filter described herein may be fabricated using injection molding, extrusion molding, rotational molding, or 3D printing.

Provided below are faucet inlet hose assemblies comprising an integrated filter, and filters that can be installed into faucet inlet hose assemblies.

Faucet Inlet Hose Assemblies with Integrated Filter

As explained above, conventional faucet hose assemblies do not include an integrated filter. If a filter is desired, a separate adaptor assembly must be purchased and coupled to the faucet inlet hose assembly to achieve a filtering system. However, faucet inlet hose assemblies provided herein include an integrated filter, thus minimizing the extra parts (i.e., separate adaptor assembly), cost, and labor required to achieve a faucet inlet hose assembly that filters sediment, debris, and/or minerals from the water that passes through and out of the faucet. Accordingly, the faucet inlet hose assemblies having an integrated filter described herein filter impurities from the water as it flows into the faucet inlet hose and through the faucet.

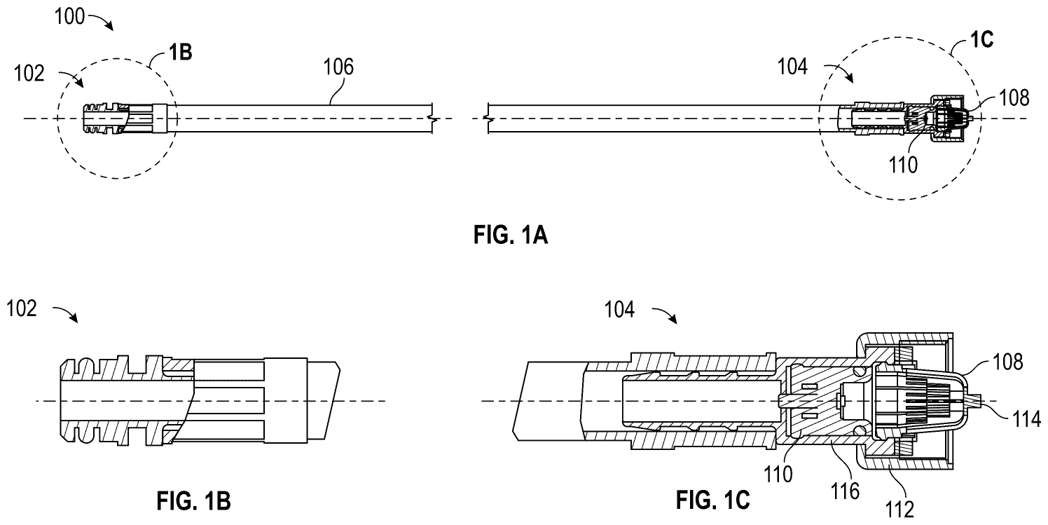

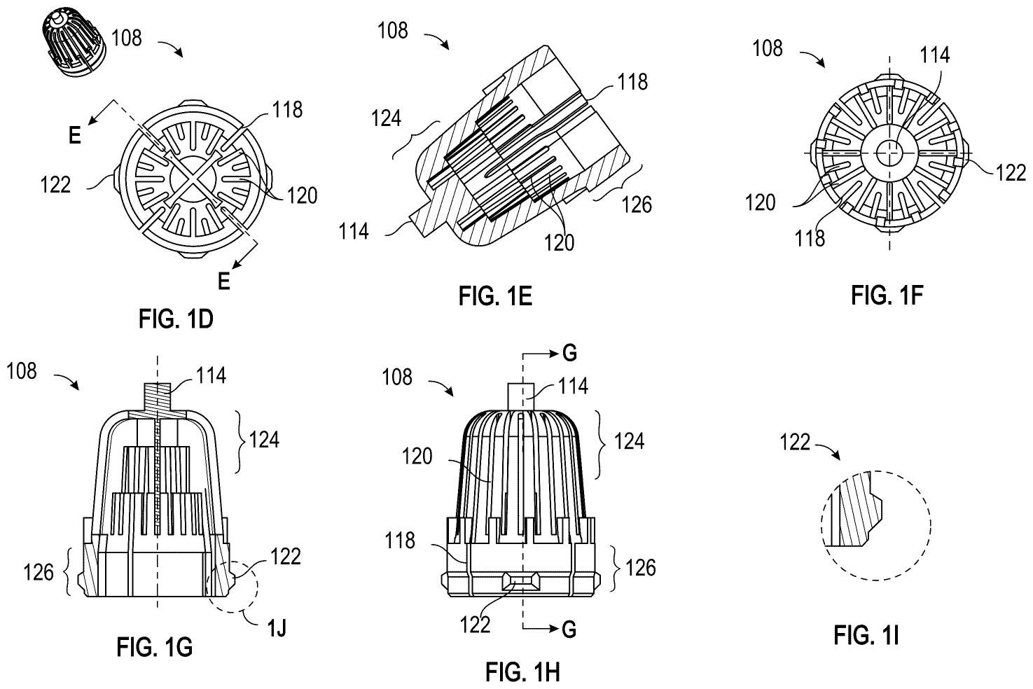

FIG. 1A illustrates a faucet inlet hose assembly 100 according to some embodiments. As shown, faucet inlet hose assembly 100 includes a first hose end 104, a second hose end 102, and hose 106. Second hose end 102 is configured to couple directly to a faucet. First hose end 104 is configured to couple to a water source (e.g., a shut-off valve of a water pipe). Hose 106 may be any known faucet inlet hose material known in the art. In some embodiments, hose 106 may comprise two layers. For example, hose 106 may comprise an ethylene propylene diene monomer rubber inner layer or Softpex® and a braided stainless steel or braided nylon outer layer.

First hose end 104 is configured to couple to a water source (e.g., a shut-off valve connected to a water supply pipe). As shown, first hose end 104 includes check valve 110 and filter 108. Filter 108 is configured to prevent the flow of impurities from entering the faucet inlet hose and passing through and out of the faucet. Check valve 110 can prevent the backflow of water. Second hose end 102 is configured to couple directly to a faucet.

FIG. 1B shows a close-up view of second hose end 102. In some embodiments, second hose end 102 may connect to a faucet using one or more of threads, a nut, a coupler, a pipe fitting, or similar type of connection method. More specifically, second hose end 102 may be configured to connect to a faucet using a push-to-connect fitting, a compression fitting, a slip fitting, a threaded fitting, a sweat fitting, a flare fitting, a crimp fitting, or a clamp fitting. Additionally, second hose end 102 may be a male connector that has a diameter of 6-18 mm. In some embodiments, the diameter of second hose end 102 may be less than or equal to about 18, about 16, about 14, about 12, about 10, or about 8 mm. In some embodiments, the diameter of second hose end 102 may be greater than or equal to 6 about, about 8, about 10, about 12, about 14, or about 16 mm. In some embodiments, second hose end 102 may comprise a coupling nut.

FIG. 1C shows a close up view of first hose end 104 (i.e., first hose end 104 of FIG. 1A). As shown, FIG. 1C includes filter 108, check valve 110, coupling nut 112, and hose connector 116. In some embodiments, filter 108 is coupled to check valve 110. In some cases, check valve 110 is coupled to hose connector 116 that is coupled to the end (i.e., inlet) of the hose. As shown, coupling nut 112 surrounds most of filter 108 and a portion of check valve 110. In some embodiments, a portion of filter 108 extends out of coupling nut 112.

Filter 108 comprises a connection portion and a convex portion. The portion of filter 108 of FIG. 1C that is shown extending out of coupling nut 112 and away from the hose is the convex portion. The connection portion is coupled to hose connector 116 and is proximate to the hose. In some embodiments, filter 108 couples to hose connector 116 such that a bottommost surface of filter 108 (i.e., the connection portion) is inside and surrounded by an opening of hose connector 116. Additionally, filter 108 may include gripping protrusion 114 configured to allow for a tool to grip and manipulate filter 108. As shown, gripping protrusion 114 extends out of the convex portion of filter 108. A tool may be used to grip gripping protrusion 114 to remove, adjust, replace, or insert filter 108.

### Filters for Faucet Inlet Hose Assemblies

In addition to the faucet inlet hose assemblies provided above, also provided are removable filters for use in faucet inlet hose assemblies. In some embodiments, the filters provided herein may be used as replacement parts for faucet inlet hose assemblies comprising an integrated filter. In some embodiments, the filters provided herein may be configured to couple to conventional faucet inlet hose assemblies.

FIGS. 1D-1I show various views of a filter according to some embodiments. Specifically, FIG. 1D shows a bottom view of a filter, FIG. 1E shows a cross-sectional view of a filter, FIG. 1F shows a top view of a filter, FIG. 1G shows a cross-sectional view of a filter, FIG. 1H shows a side view of a filter, and FIG. 1I shows a close-up view of a coupling protrusion. Each figure is described in detail below.

FIG. 1D shows a bottom view of a filter 108 according to some embodiments. Specifically, FIG. 1D shows a perspective of filter 108 from the connection portion, looking up into filter 108 at an interior surface of the convex portion. Thus, FIG. 1D shows a bottommost surface of filter 108 (i.e., at the connection portion) and an interior surface of filter 108.

Filter 108 of FIG. 1D includes a plurality of cut-outs 118, a plurality of channels 120, and a connection portion comprising a plurality of coupling protrusions 122. Each of these features is explained in detail below.

As shown, filter 108 of FIG. 1D includes a plurality of cut-outs 118. Specifically, filter 108 shows four cut-outs 118. Each cut-out 118 protrudes radially into filter 108 towards a center axis that runs from a center of the connection portion to a center of the convex portion. Based on the perspective provided in FIG. 1D, the center axis runs into and out of the page. The plurality of cut-outs 118 are provided to allow the filter to flex and distort slightly for easier maneuvering during installation and removal.

Although filter 108 is shown with four cut-outs 118, filter 108 may include between about 2 and about 10 cut-outs 118. In some embodiments, filter 108 comprises less than or equal to about 10, about 9, about 8, about 7, about 6, about 5, about 4, or about 3 cut-outs 118. In some embodiments, filter 108 comprises greater than or equal to about 2, about 3, about 4, about 5, about 6, about 7, about 8, or about 9 cut-outs 118. Additionally, as shown in FIG. 1D, each cut-out 118 is shown extending radially towards a center axis of filter 108, as explained above. However, each cut-out 118 does not extend the complete radial distance to the center axis. In some embodiments, the cut-outs 118 extend through the base of the connection portion of filter 108. In some embodiments, the cut-outs 118 extend a portion of the total distance between the base of a connection portion and a topmost location of a convex portion, but do not extend through the base of the connection portion. In some embodiments, each cut-out 118 may extend between about 20% and about 80% of the radial distance of a base of the connection portion. In some embodiments, each cut-out 118 may extend less than or equal to about 80%, about 70%, about 60%, about 50%, about 40%, or about 30% the radial distance of the connection portion. In some embodiments, each cut-out 118 may extend greater than or equal to about 20%, about 30%, about 40%, about 50%, about 60%, or about 70% the radial distance of the connection portion. In some embodiments, each cut-out 118 is substantially the same size. In some embodiments, a first cut-out 118 may have a radial length greater than that of a second cut-out 118. In some embodiments, the plurality of cut-outs 118 are spaced substantially evenly around a circumference of the connection portion. In some embodiments, the plurality of cut-outs 118 are not spaced substantially evenly around the circumference of the connection portion.

As explained above, cut-outs 118 are provided to allow the filter 108 to flex and distort slightly for easier maneuvering during installation and removal. As shown, cut-out 118 extends laterally along a portion of the sidewall of filter 108, in a direction that extends from connection portion 126 towards convex portion 124. Cut-outs 118 originate at a base of filter 108 (i.e., where a bottom surface of filter 108 meets the sidewall of connection portion 126) and may not extend all the way to convex portion 124. In some embodiments, cut-outs 118 can extend between about 20% and about 90% that of a total distance along the sidewall of filter 108, the total distance being measured from the base of filter 108 (i.e., at connection portion 126) to the center of convex portion 124 and the topmost location of filter 108 (i.e., the location from which gripping protrusion 114 extends). In some embodiments, cut-outs 118 may extend a distance along the sidewall of filter 108 that is less than or equal to about 90%, about 80%, about 70%, about 60%, about 50%, about 40%, or about 30% that of the total distance from the base of filter 108 to the center of convex portion 124. In some embodiments, cut-outs 118 may extend a distance along the sidewall of filter 108 that is greater than or equal to about 20%, about 30%, about 40%, about 50%, about 60%, about 70%, or about 80% that of the total distance from the base of filter 108 to the center of convex portion 124. In some embodiments, a first cut-out 118 may extend a distance that is greater than that of a second cut-out 118.

Filter 108 also includes a plurality of channels 120. As shown in FIG. 1D, each channel 120 is shown from an interior surface of filter 108. Each channel 120 extends from an interior surface of filter 108 to an exterior surface 108 and is configured to allow water to pass through. Specifically, channels 120 are configured to allow water to pass through but prevent the passage of debris, minerals, and/or sediment. As shown, channels 120 may only extend along a portion of the sidewall of filter 108. Channels 120 can extend laterally along filter 108 in a direction that extends from convex portion 124 to connection portion 126 such that a length of each channel 120 (extending laterally) is greater than a width of each channel (extending in a direction perpendicular to the direction extending from convex portion 124 to connection portion 126).

Each channel 120 at the convex portion of filter 108 as shown, and extends toward the connection portion of filter 108. However, a first channel 120 may originate at a position that is closer to the center of the convex portion (i.e., a topmost location of filter 108) than a second channel 120. In some embodiments, each channel 120 extends from the convex portion of filter 108 and towards the connection portion of filter 108. However, the channels 120 may not extend all the way to the base of filter 108 (i.e., where a bottom surface of filter 108 meets the connection portion of filter 108). In some embodiments, a channel 120 extends between about 30% and about 90% the distance between a topmost location of the convex portion and a bottommost location of the connection portion of filter 108. In some embodiments, a channel 120 extends less than or equal to about 90%, about 80%, about 70%, about 60%, about 50%, or about 40% the distance between a topmost location of the convex portion and a bottommost location of the connection portion of filter 108. In some embodiments, a first channel 120 may extend further along the distance (and thus be longer) than a second channel 120. In some embodiments, each channel 120 may be substantially the same length. In some embodiments, a first channel 120 originates from a location that is substantially the same distance from the topmost location of the convex portion as the location from which a second channel 120 originates. In some embodiments, a first channel 120 may originate from a location that is further from the topmost location of the convex portion than a location from which a second channel 120 originates.

As shown, filter 108 comprises twenty channels 120. However, filter 108 according to some embodiments may comprise any number of channels 120 between about 4 and about 40. Filters that comprise more channels may allow for a higher flow rate of water to pass through. Filters that comprise fewer channels may allow for a lower flow rate of water to pass through. In some embodiments filter 108 may comprise less than or equal to about 40, about 38, about 36, about 35, about 34, about 32, about 30, about 28, about 26, about 25, about 24, about 22, about 20, about 18, about 16, about 15, about 14, about 12, about 10, about 8, or about 6 channels 120. In some embodiments, filter 108 comprises greater than or equal to about 4, about 5, about 6, about 8, about 10, about 12, about 14, about 15, about 16, about 18, about 20, about 22, about 24, about 25, about 26, about 28, about 30, about 32, about 34, about 35, about 36, or about 38 channels 120.

The length and width of each channel 120 is optimized to allow water to pass through filter 108 at an adequate flow rate, while also preventing the passage of common sediment, debris, and/or minerals. In some embodiments, a width of each channel 120 is between about 0.1 and about 2 mm. In some embodiments, a width of each channel 120 is less than or equal to about 2, about 1.8, about 1.6, about 1.4, about 1.2, about 1, about 0.8, about 0.6, about 0.4, or about 0.2 mm. In some embodiments, a width of each channel 120 is greater than or equal to about 0.1, about 0.2, about 0.4, about 0.6, about 0.8, about 1, about 1.2, about 1.4, about 1.6, or about 1.8 mm. In some embodiments, a length of each channel 120 is between about 3 and about 15 mm. In some embodiments, a length of each channel 120 is less than or equal to about 15, about 14, about 13, about 12, about 11, about 10, about 9, about 8, about 7, about 6, about 5, or about 4 mm. In some embodiments, each channel 120 is greater than or equal to about 3, about 4, about 5, about 6, about 7, about 8, about 9, about 10, about 11, about 12, about 13, or about 14 mm. In some embodiments, the length-to-width ratio of each channel 120 is between about 10 and about 50. In some embodiments, the length-to-width ratio of each channel 120 is less than or equal to about 50, about 45, about 40, about 35, about 30, about 25, about 20, or about 15. In some embodiments, the length-to-width ratio of each channel 120 is greater than or equal to about 10, about 15, about 20, about 25, about 30, about 35, about 40, or about 45.

Filter 108 also comprises a fitting that includes a plurality of coupling protrusions 122. Coupling protrusions 122 are configured to hold filter 108 to a coupling fitting of faucet inlet hose assembly 100. In some embodiments, coupling protrusions 122 may be configured to couple filter 108 to hose connector 116 of faucet inlet hose assembly 100. In some embodiments, coupling protrusions 122 may be configured to couple filter 108 to coupling nut 112 or hose connector 116 of faucet inlet hose assembly 100.

As shown in FIG. 1C and explained above, the connection portion of filter 108 may be configured to couple to hose connector 116 such that the connection portion of filter 108 is inserted into an open end of hose connector 116. For example, the connection portion may be coupled to a faucet hose assembly using a snap fitting. In this case, the connection portion is completely surrounded by the open end of hose connector 116. Coupling protrusions 122 may be configured to snap the connection portion of filter 108 to hose connector 116. For example, with regards to FIG. 1D, a coupling protrusion 122 may be configured to snap into an indentation along an inner surface of hose connector 116. As shown, filter 108 of FIG. 1D comprises four coupling protrusions 122. However, filter 108 can comprise any number of coupling protrusions 122 between about 2 and about 10. In some embodiments, filter 108 comprises less than or equal to about 10, about 9, about 8, about 7, about 6, about 5, about 4, or about 3 coupling protrusions 122. In some embodiments, filter 108 comprises greater than or equal to about 2, about 3, about 4, about 5, about 6, about 7, about 8, or about 9 coupling protrusions 122. In some embodiments, filter 108 may comprises a coupling protrusion 122 in the form of a protruding ridge that extends along at least a portion of the base of filter 108. A protruding ridge may be configured to mate with an indentation along an inner surface of hose connector 116. In some embodiments, filter 108 may comprise threads that allow filter 108 to screw into hose connector 116.

In some embodiments, connection portion 126 may comprise an outer diameter that measures between about 4 and about 15 mm. In some embodiments, the outer diameter of connection portion 126 may be less than or equal to about 15, about 14, about 13, about 12, about 11, about 10, about 9, about 8, about 7, about 6, or about 5 mm. In some embodiments, the outer diameter of connection portion 126 may be greater than or equal to about 4, about 5, about 6, about 7, about 8, about 9, about 10, about 11, about 12, about 13, or about 14 mm. In some embodiments, convex portion 124 may comprise an outer diameter that measures between about 2 and about 12 mm. In some embodiments, the outer diameter of convex portion 124 may be less than or equal to about 12, about 11, about 10, about 9, about 8, about 7, about 6, about 5, about 4, or about 3 mm. In some embodiments, the outer diameter of convex portion 124 may be greater than or equal to about 2, about 3, about 4, about 5, about 6, about 7, about 8, about 9, about 10, or about 11 mm.

FIG. 1E shows a cross-sectional view of filter 108 according to some embodiments. For example, filter 108 may be a cross-sectional view along E-E as shown in FIG. 1D. As shown, filter 108 of FIG. 1E may include a convex portion 124, a connection portion 126, a plurality of cut-outs 118, a plurality of channels 120, and a gripping protrusion 114.

As shown, filter 108 may be convex-shaped. A first end is a convex-shaped (i.e., convex portion 124) and a second end is open and circular (i.e., connection portion 126). A tapered sidewall connects convex portion 124 and connection portion 126.

Gripping protrusion 114 protrudes from a center of convex portion 124 and an uppermost location of filter 108. A tool may be used to grip gripping protrusion 114 to remove, adjust, replace, or insert filter 108.

FIG. 1F shows a top view of filter 108 according to some embodiments. Specifically, FIG. 1F shows a straight-on view of the convex portion of filter 108. Filter 108 of FIG. 1F comprises a plurality of coupling protrusions 122, a plurality of cut-outs 118, and a gripping protrusion 114, and a plurality of channels 120.

FIG. 1G shows a cross-sectional view of filter 108 according to some embodiments. Specifically, FIG. 1G provides a cross-sectional view along line G-G as shown in FIG. 1H. Filter 108 of FIG. 1G includes a convex portion 124, a connection portion 126, gripping protrusion 114, and a fitting comprising a plurality of coupling protrusions 122.

As shown, filter 108 includes a sidewall that extends between connection portion 126 and convex portion 124. In some embodiments, a radius of convex portion 124 may be less than a radius of connection portion 126, such that the sidewall extending between connection portion 126 and convex portion 124 tapers as it approaches convex portion 124.

FIG. 1H shows a side view of filter 108 according to some embodiments. Filter 108 includes convex portion 124, connection portion 126, gripping protrusion 114, a plurality of channels 120, a plurality of cut-outs 118, and a plurality of coupling protrusions 122.

Gripping protrusion 114 extends upwards from an uppermost surface of filter 108, or from a center of convex portion 124. In some embodiments, gripping protrusion 114 has a height that extends in a direction of a height of filter 108 (i.e., in a direction extending along a central axis from a center of connection portion 126 to a center of convex portion 124, wherein the central axis passes through gripping protrusion 114). In some embodiments, the height of gripping protrusion 114 is between about 0.5 and about 5 mm. In some embodiments, the height of gripping protrusion 114 is less than or equal to about 5, about 4.5, about 4, about 3.5, about 3, about 2.5, about 2, about 1.5, or about 1 mm. In some embodiments, the height of gripping protrusion 114 is greater than or equal to about 0.5, about 1, about 1.5, about 2, about 2.5, about 3, about 3.5, about 4, or about 4.5 mm, in some embodiments, gripping protrusion 114 has a width that extends in a direction perpendicular to its height. In some embodiments, the width of gripping protrusion 114 is about 0.2 to about 5 mm. In some embodiments, the width of gripping protrusion 114 is less than or equal to about 5, about 4.5, about 4, about 3.5, about 3, about 2.5, about 2, about 1.5, about 1, or about 0.5 mm. In some embodiments, the width of gripping protrusion 114 is greater than or equal to about 0.2, about 0.5, about 1, about 1.5, about 2, about 2.5, about 3, about 3.5, about 4, or about 4.5 mm.

In some embodiments, filter 108 comprises a height as measured in a direction that extends from connection portion 126 to convex portion 124 (i.e., in a direction extending along a central axis from a center of connection portion 126 to a center of convex portion 124, wherein the central axis passes through gripping protrusion 114). In some embodiments, a height of filter 108 (excluding gripping protrusion 114) is between about 5 and about 40 mm. In some embodiments, a height of filter 108 (excluding gripping protrusion 114) is less than or equal to about 40, about 35, about 30, about 25, about 20, about 15, or about 10 mm. In some embodiments, a height of filter 108 (excluding gripping protrusion 114) is greater than or equal to about 10, about 15, about 20, about 25, about 30, or about 35 mm.

FIG. 1I shows a close-up view of a coupling protrusion 122 according to some embodiments. As explained above, filters 108 according to embodiments provided herein can include a fitting configured to removably couple the filter 108 to faucet inlet hose assembly 100. For example, the fitting of filters 108 described herein may be configured to removeably couple the filter 108 to one or more of a check valve 110, a nut 112, or a hose connector 116 of a hose end of faucet inlet hose assembly 100. In some embodiments, the fitting of filter 108 may include one or more coupling protrusions 122, such as the coupling protrusion 122 of FIG. 1I.

Coupling protrusion 122 may be configured to snap into a complementary indentation. For example, one of a check valve 110, a nut 112, or a hose connector 116 may include an indentation configured to receive coupling protrusion 122. In some embodiments, filter 108 according to embodiments provided herein may include a plurality of coupling protrusions 122. In some embodiments, coupling protrusion 122 may extend circumferentially around a portion of a connection portion 126 of filter 108 according to some embodiments described herein.

In some embodiments, coupling protrusion 122 may extend between about 0.2 and about 3 mm up the sidewall of a filter from the bottom surface of the connection portion 126 (i.e., a height of the coupling protrusion 122). In some embodiments, the height of the coupling protrusion 122 is less than or equal to about 3, about 2.5, about 2, about 1.5, about 1, or about 0.5 mm. In some embodiments, a height of the coupling protrusion 122 is greater than or equal to about 0.3, about 0.5, about 1, about 1.5, about 2, or about 2.5 mm. In some embodiments, coupling protrusion 122 may extend circumferentially around a portion of the base of the connection portion 126. In some embodiments, coupling protrusion 122 extends between about 1 and about 50% the circumference of the base of the connection portion 126 of filter 108 according to embodiments provided herein. In some embodiments, coupling protrusion 122 extends less than or equal to about 50%, about 45%, about 40%, about 35%, about 30%, about 25%, about 20%, about 15%, about 10%, about 5%, or about 2% of the circumference of the base of connection portion 126. In some embodiments, coupling protrusion 122 extends greater than or equal to about 1%, about 2%, about 5%, about 10%, about 15%, about 20%, about 25%, about 30%, about 25%, about 40%, or about 45% of the circumference of the base of connection portion 126.

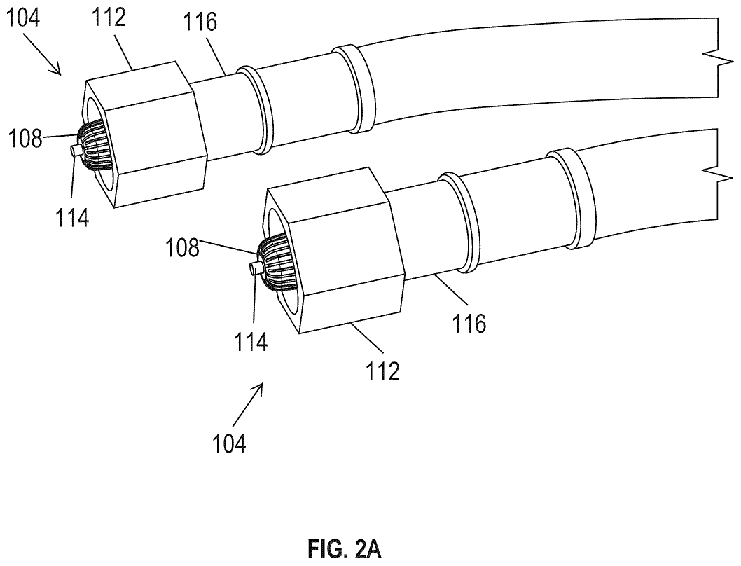

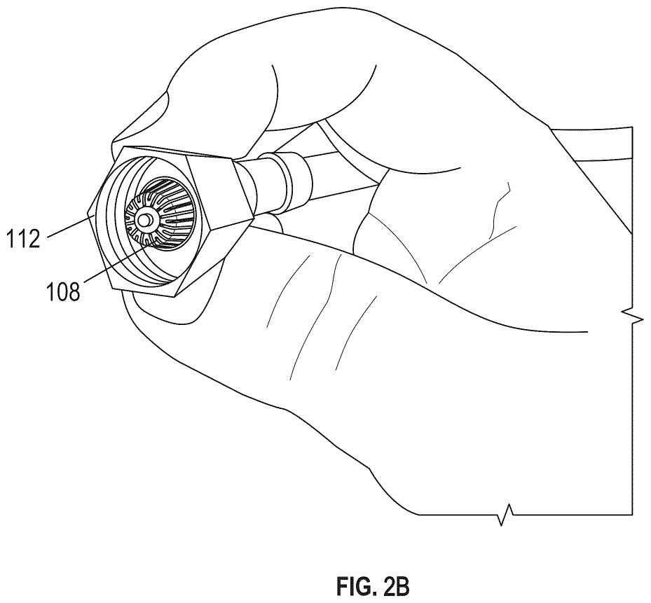

FIG. 2A shows an image of a first hose end 104 and a first coupling fitting of a faucet inlet hose assembly according to some embodiments. Specifically, FIG. 2A shows a first hose end 104 and first coupling fitting of a faucet inlet hose assembly for both a hot water supply hose and a cold water supply hose. As shown in the Figure, filter 108 is connected to each first hose end 104 of each hose assembly.

FIG. 2B shows an image of a faucet inlet hose assembly according to some embodiments. As shown in the Figure, filter 108 is coupled to hose connector 116 such that a portion of filter 108 is inserted into the opening of hose connector 116. Thus, a portion of hose connector 116 surrounds the base of filter 108.

### Embodiments

Embodiment 1. A faucet inlet hose assembly having an integrated filter, the faucet inlet hose assembly comprising: a hose comprising a first hose end and a second hose end; a first coupling fitting, wherein the first hose end terminates at the first coupling fitting; a second coupling fitting, wherein the second hose end terminates at the second coupling fitting; a hose connector connected to the first hose end; and a filter at least partially within the first coupling fitting and coupled to the hose connector.

Embodiment 2. The faucet inlet hose assembly of embodiment 1, wherein the first coupling fitting comprises a check valve, a nut, and the hose connector.

Embodiment 3. The faucet inlet hose assembly of embodiment 1 or 2, wherein the filter comprises a convex portion and a connection portion, and the convex portion extends away from the first hose end.

Embodiment 4. The faucet inlet hose assembly of any of embodiments 1-3, wherein the first coupling fitting is configured to connect to a water source.

Embodiment 5. The faucet inlet hose assembly of any of embodiments 1-4, wherein the first coupling fitting is configured to connect to a faucet.

Embodiment 6. The faucet inlet hose assembly of embodiment 3, wherein the connection portion comprises a fitting that removably connects to the check valve.

Embodiment 7. The faucet inlet hose assembly of embodiment 6, wherein the fitting comprises a snap fitting.

Embodiment 8. The faucet inlet hose assembly of any of embodiments 1-7, wherein the second coupling fitting comprises a nut.

Embodiment 9. The faucet inlet hose assembly of any of embodiments 1-8, wherein the filter comprises a plurality of channels.

Embodiment 10. The faucet inlet hose assembly of embodiment 9, wherein each channel of the plurality of channels extends from the convex portion towards the connection portion.

Embodiment 11. The faucet inlet hose assembly of embodiments 9 or 10, wherein the plurality of channels comprises 15-25 channels.

Embodiment 12. The faucet inlet hose assembly of any of embodiments 9-11, wherein the plurality of channels are substantially evenly spaced around the filter.

Embodiment 13. The faucet inlet hose assembly of any of embodiments 9-12, wherein a length of a first channel of the plurality of channels is greater than a length of a second channel of the plurality of channels, wherein a length is measured along a surface of the filter extending from the convex portion to the connection portion.

Embodiment 14. The faucet inlet hose assembly of any of embodiments 9-13, wherein a length of each channel of the plurality of channels extends from about 50% to about 80% of a total distance measured along an exterior surface of the filter extending from a center of the convex portion to a bottommost location of the connection portion.

Embodiment 15. The faucet inlet hose assembly of any of embodiments 1-14, wherein the filter comprises a gripping protrusion extending from a center of the convex portion, the gripping protrusion configured to allow a tool to grip the filter.

Embodiment 16. The faucet inlet hose assembly of any of embodiments 1-15, wherein the filter comprises a plurality of cut-outs extending from the connection portion towards the convex portion.

Embodiment 17. The faucet inlet hose assembly of embodiment 15, wherein each cut-out of the plurality of cut-outs extends from about 50% to about 80% of a total distance measured along an exterior surface of the filter extending from a center of the convex portion to a bottommost location of the connection portion.

Embodiment 18. The faucet inlet hose assembly of any of embodiments 1-17, wherein the filter comprises a metal or a thermoplastic or elastomer.

Embodiment 19. The faucet inlet hose assembly of embodiment 18, wherein the filter comprises one or more of a metal such as stainless steel, aluminum, or brass; a thermoplastic such as polyamide, acrylic, polycarbonate, polyoxymethylene, polyester, polystyrene, polypropylene, polyethylene, polyurethane, polyphenylene sulfite, polyphenylene oxide, polysulfone, polyphthalamide, combinations thereof or copolymers thereof; or an elastomer such as acrylonitrile-butadiene-styrene or silicone rubber.

Embodiment 20. A filter for a faucet inlet hose assembly comprising: a convex portion; and a connection portion opposite the convex portion, wherein the connection portion is configured to removably couple to a hose connector of a faucet inlet hose.

Embodiment 21. The filter of embodiment 20, wherein the connection portion comprises a snap fitting.

Embodiment 22. The filter of embodiments 20 or 21, wherein the filter comprises a plurality of channels.

Embodiment 23. The filter of embodiment 22, wherein each channel of the plurality of channels extends from the convex portion towards the connection portion of the filter.

Embodiment 24. The filter of embodiments 22 or 23, wherein the plurality of channels comprises 15-25 channels.

Embodiment 25. The filter of any of embodiments 22-24, wherein the plurality of channels are substantially evenly spaced around the filter.

Embodiment 26. The filter of any of embodiments 22-25, wherein a length of a first channel of the plurality of channels is greater than a length of a second channel of the plurality of channels, wherein a length is measured along a surface of the filter extending from the convex portion to the connection portion.

Embodiment 27. The filter of any of embodiments 22-26, wherein a length of each channel of the plurality of channels extends from about 50% to about 80% of a total distance measured along an exterior surface of the filter extending from a center of the convex portion to a bottommost location of the connection portion.

Embodiment 28. The filter of any of embodiments 20-27, wherein the filter comprises a gripping protrusion extending from a center of the convex portion, the gripping protrusion configured to allow a tool to grip the filter.

Embodiment 29. The filter of any of embodiments 20-28, wherein the filter comprises a plurality of cut-outs extending from the connection portion towards the convex portion.

Embodiment 30. The filter of embodiment 29, wherein each cut-out of the plurality of cut-outs extends from about 50% to about 80% of a total distance measured along an exterior surface of the filter extending from a center of the convex portion to a bottommost location of the connection portion.

Embodiment 31. The filter of any of embodiments 20-30, wherein the filter comprises one or more of a metal such as stainless steel, aluminum, or brass; a thermoplastic such as polyamide, acrylic, polycarbonate, polyoxymethylene, polyester, polystyrene, polypropylene, polyethylene, polyurethane, polyphenylene sulfite, polyphenylene oxide, polysulfone, polyphthalamide, combinations thereof or copolymers thereof; or an elastomer such as acrylonitrile-butadiene-styrene or silicone rubber.

The foregoing description sets forth exemplary systems, methods, techniques, parameters, and the like. It should be recognized, however, that such description is not intended as a limitation on the scope of the present disclosure but is instead provided as a description of exemplary embodiments.

Although the description herein uses terms first, second. etc. to describe various elements, these elements should not be limited by the terms. These terms are only used to distinguish one element from another.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, 0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, 3%, ±4%, ±5%, ±6%, ±7%, ±8%, ±9%, ±10% or more of the definition; for example the term “substantially perpendicular” may mean the 900 perpendicular angle may mean “about 90°”. The term “generally” may be equivalent to “substantially”.

For any of the structural and functional characteristics described herein, methods of determining these characteristics are known in the art.

1. A faucet inlet hose assembly having an integrated filter, the faucet inlet hose assembly comprising:
a hose comprising a first hose end and a second hose end;
a first coupling fitting, wherein the first hose end terminates at the first coupling fitting;
a second coupling fitting, wherein the second hose end terminates at the second coupling fitting;
a hose connector connected to the first hose end; and
a filter at least partially within the first coupling fitting and coupled to the hose connector.

2. The faucet inlet hose assembly of claim 1, wherein the first coupling fitting comprises a check valve, a nut, and the hose connector.

3. The faucet inlet hose assembly of claim 1, wherein the filter comprises a convex portion and a connection portion, and the convex portion extends away from the first hose end.

4. The faucet inlet hose assembly of claim 1, wherein the first coupling fitting is configured to connect to a water source.

5. The faucet inlet hose assembly of claim 3, wherein the connection portion comprises a fitting that removably connects to the check valve, and the fitting comprises a snap fitting.

6. The faucet inlet hose assembly of claim 1, wherein the filter comprises a plurality of channels, wherein each channel of the plurality of channels extends from the convex portion towards the connection portion.

7. The faucet inlet hose assembly of claim 6, wherein a length of a first channel of the plurality of channels is greater than a length of a second channel of the plurality of channels, wherein a length is measured along a surface of the filter extending from the convex portion to the connection portion.

8. The faucet inlet hose assembly of claim 6, wherein a length of each channel of the plurality of channels extends from about 50% to about 80% of a total distance measured along an exterior surface of the filter extending from a center of the convex portion to a bottommost location of the connection portion.

9. The faucet inlet hose assembly of claim 1, wherein the filter comprises a gripping protrusion extending from a center of the convex portion, the gripping protrusion configured to allow a tool to grip the filter.

10. The faucet inlet hose assembly of claim 1, wherein the filter comprises a plurality of cut-outs extending from the connection portion towards the convex portion.

11. The faucet inlet hose assembly of claim 10, wherein each cut-out of the plurality of cut-outs extends from about 50% to about 80% of a total distance measured along an exterior surface of the filter extending from a center of the convex portion to a bottommost location of the connection portion.

12. The faucet inlet hose assembly of claim 1, wherein the filter comprises one or more of a metal such as stainless steel, aluminum, or brass; a thermoplastic such as polyamide, acrylic, polycarbonate, polyoxymethylene, polyester, polystyrene, polypropylene, polyethylene, polyurethane, polyphenylene sulfite, polyphenylene oxide, polysulfone, polyphthalamide, combinations thereof or copolymers thereof, or an elastomer such as acrylonitrile-butadiene-styrene or silicone rubber.

13. A filter for a faucet inlet hose assembly comprising:
a convex portion; and
a connection portion opposite the convex portion, wherein
the connection portion is configured to removably couple to a hose connector of a faucet inlet hose.

14. The filter of claim 13, wherein the connection portion comprises a snap fitting.

15. The filter of claim 13, wherein the filter comprises a plurality of channels, wherein each channel of the plurality of channels extends from the convex portion towards the connection portion of the filter.

16. The filter of claim 15, wherein a length of a first channel of the plurality of channels is greater than a length of a second channel of the plurality of channels, wherein a length is measured along a surface of the filter extending from the convex portion to the connection portion.

17. The filter of claim 15, wherein a length of each channel of the plurality of channels extends from about 50% to about 80% of a total distance measured along an exterior surface of the filter extending from a center of the convex portion to a bottommost location of the connection portion.

18. The filter of claim 13, wherein the filter comprises a plurality of cut-outs extending from the connection portion towards the convex portion.

19. The filter of claim 18, wherein each cut-out of the plurality of cut-outs extends from about 50% to about 80% of a total distance measured along an exterior surface of the filter extending from a center of the convex portion to a bottommost location of the connection portion.

20. The filter of claim 13, wherein the filter comprises one or more of a metal such as stainless steel, aluminum, or brass; a thermoplastic such as polyamide, acrylic, polycarbonate, polyoxymethylene, polyester, polystyrene, polypropylene, polyethylene, polyurethane, polyphenylene sulfite, polyphenylene oxide, polysulfone, polyphthalamide, combinations thereof or copolymers thereof, or an elastomer such as acrylonitrile-butadiene-styrene or silicone rubber.
